(19) United States
(12) Patent Application Publication
(10) Pub. No.: US 2004/0200892 A1
(43) Pub. Date: Oct. 14, 2004

(54) Method and system for anonymous trace-back of food item label claims

(76) Inventors: LeLand D. Curkendall, Cheyenne, WY (US); William R. Pape, Los Ojos, NM (US); Andrew J. Dolan, Arvada, CO (US)

Correspondence Address: Rick B. Yeager, 10805 Mellow Lane, Austin, TX, 78759, US

(21) Appl. No.: 10/795,871

(22) Filed: Mar. 8, 2004

Related U.S. Application Data
(60) Provisional application No. 60/453,401, filed on Mar. 7, 2003.

(51) Int. Cl. G06F 7/00

(52) U.S. Cl. 235/376; 707/10; 340/5.9

(57) ABSTRACT

A method and system for maintaining source anonymity while providing food item source verification to substantiate a label claim, such as Country of Origin (COOL) labeling. A database, such as a transactional event database, records a private entity ID including events related to the labeling; and shipping and receiving events. One or more data view, such as a relational database data mart, is constructed from the event data so that a public ID replaces the entity private ID. In an authorized audit, the public ID is decoded to the private ID.

### RELATED APPLICATIONS

This application is related to and claims priority from U.S. Provisional patent application No. 60/453,401 filed Mar. 7, 2003. Much of the background and specification for this application is described in applicant's copending application Ser. No. 10/364,849 filed Feb. 11, 2003 and published Sep. 18, 2003 as US20030177025A1 for Method and system for agricultural data collection and management, and is incorporated by reference in this application.

### FIELD OF INVENTION

This invention relates to a method and system for providing source verification in order to substantiate a label claim, such as Country of Origin (COOL) labeling, for food items.

### BACKGROUND

It is desirable to substantiate food label claims by providing source and process verification for food items where the ingredients for the final food item are sourced from various different supply chains, each chain having one or more segments of production. Each prior segment of production within each chain typically involves one or more companies. In some instances product labeling such as Country of Origin Labeling (COOL) may be required by law. In some cases, it is desirable to provide this source verification in a manner that maintains the anonymity of ownership of the earlier owners of each ingredient from prior segments of production so that market relationships are not disturbed. However, in the event of an audit or the need to provide a trace-back related to a food product recall, it is desirable for an authorized individual, such as an inspector to be able to quickly determine the actual identity of the specific companies in the supply chain for the food item for any ingredient that constituted that item. This audit or recall trace-back may be applied at any company at any segment in the processing chain.

### SUMMARY

The present invention provides an origin and process verification for all food, fresh and processed, in a manner that provides traceability, either forwards or backwards, for all ingredients while maintaining anonymity of ownership. The anonymity is preserved, thereby preserving market relationships. Although the methods of the present invention can be used for any aspect of food traceability, the simple example of Country of Origin Labeling (COOL) for beef products will be used as an example of implementation. Other examples might include compliance with animal welfare requirements, compliance with antibiotic regimens, or compliance with fair trade practices in dealing with the initial farmer or rancher. Typically, the entity to whom an item is transferred must be able to see from whom the item is coming because they are purchasing the item. The method and system of the current invention provides that functionality without exposing to the current buyer the identity of any previous owner. Some systems have attempted to obscure the identity of previous owners by assigning an upstream owner a single identification number. This approach does not prevent disclosure of identity because the frequency of occurrence of a specific number will allow the knowledgeable observer to infer identity because it will be easy to spot the larger operators because their number will have a much higher occurrence frequency. So, if the ID for an upstream producer or processor is only a single number, trends for that ID number can be watched and actions taken that threaten existing marketing relationships. The current invention provides dynamic aliases for upstream owner IDs so that receivers of items will not be able to infer identity.

The current method and system is designed to efficiently meet statutory requirements, such as United States legislation on Country of Origin labeling, and other process attribute label claims.

The current method and system is designed to protect the privacy and data security of each operation (commercial entity) at each segment of the food chain for each ingredient in the food product to the stage where a specific label claim is being made.

The current method and system is designed to provide a cash-back or rebate for the producer, so that the producer has incentive to provide information to the system.

The current method and system is designed to handle the accounting associated with the reporting and with the incentives.

### BRIEF DESCRIPTION OF THE DRAWINGS

These and other objects and advantages of the present invention are set forth below and further made clear by reference to the drawings, wherein:

FIG. 1 is a flow chart of a method of the current invention.

FIG. 2 is a flow chart of a system for implementing the invention, including data entry, data extraction, data storage, and data retrieval.

FIG. 3 is a flowchart for a simple beef example of the present invention.

FIG. 4 is a table showing example database entries for the example of FIG. 3.

FIG. 5 is an example of a de-referencing table for associating public IDs with private IDs.

FIG. 6 is a flowchart illustrating a keyword encryption method for creating and decoding public IDs.

### DETAILED DESCRIPTION OF EMBODIMENT—REGISTRATION EVENTS

An entity is defined as a producer or a processor of a food item or an ingredient used in a food item. An item is defined as an edible food article including fruits or vegetables, grains or oilseeds, livestock, etc.

The description of embodiment below uses the example of substantiating a Country of Origin Label claim (COOL). The invention can be used to provide a method of substantiating any other label claim where an auditable traceback is required or desirable.

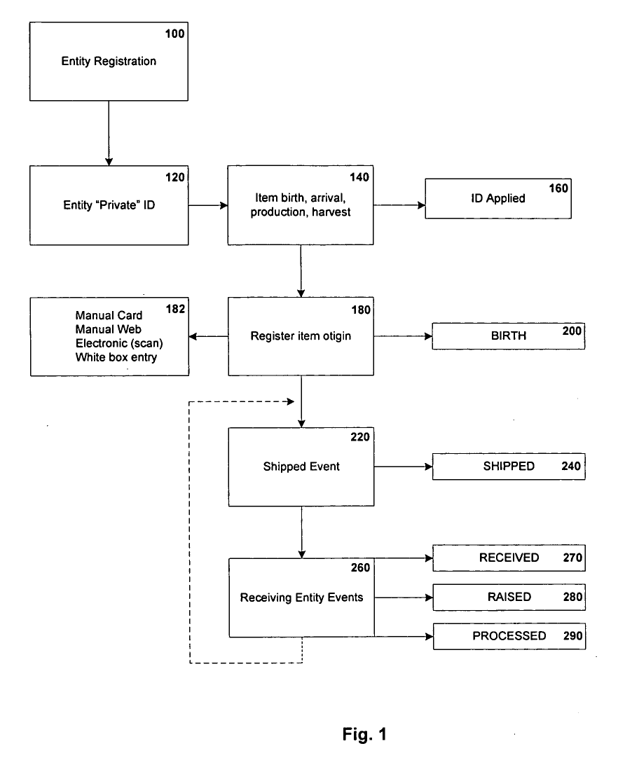

Referring now to FIG. 1, at step 100 the entity registers with a service provider such as AgInfoLink USA, Inc. An entity is defined as anyone who owns the item at any stage of production. For instance, in the case of beef, an entity or entities may be one or more of the following as discussed in the beef industry section of the US20030177025A1 patent application: Cow-calf producer, Auction facility, Stocker operator, Feedyard operator, Packinghouse, Secondary processor, Distributor, and Retailer.

At step 120, the entity is assigned a private identification number such as a 16-character alphanumeric that begins with a defined character. In this example, the first character of the private identification number is the “@” symbol. Other characters could be used. In this example, the first character will indicate that the identification number is private versus public as discussed below—the private identification number has a distinguishing feature such as a unique first character that is not present in public identification numbers. Other methods for assigning private and public keys are discussed in other embodiments below.

At step 140, the item is born, or harvested, or received by the entity. If the item does not have an item identification such as an RFID tag, bar code, visual tag, or other identification, then an identification is applied at step 160.

In this example, the item is a meat product. Upon receiving the item, the entity registers its ownership of the Item at step 180 using one of the following three COOL events:

a. COOL-BORN

b. COOL-RAISED/PRODUCED

c. COOL-PROCESSED/HARVESTED

In this embodiment, the COOL event is recorded in an event data structure of a transactional event database as described in the US20030177025A1 patent application or other database systems such as a relational or tabular database. Using the event database structure previously described, the event detail is a country such as USA, Mexico, Australia, etc., where the country designates the place of occurrence of the entity's event. For example, if the item is a calf that was born at the entity location is Mexico, then the event detail is COOL-BORN, and the event detail is Mexico. If the item is a vegetable that is harvested at an entity in the United States, then the entity location is USA, and the event detail is COOL-PROCESSED/HARVESTED. Step 200 represents the BIRTH event, where the item is an animal.

Step 182 shows possible registration methods for registering the item. Registration methods include manual registration as described in AgInfoLink USA, Inc.'s CattleCard™ product as described in U.S. Pat. No. 6,211,789; manual registration using on-line web site; electronic reading of RFID, bar code or other identification tag or device; and automatic registration via an entity's software system. In the case of beef, examples of an entity's software system include third party herd management software, third party auction management software, third party feedlot management software, third party packer management software, third party retailer management software. The communication between these third party software systems and the service provider is described in the US20030177025A1 patent application. In some cases, custom entity software may automatically provide registration data.

At step 220, as an item leaves an entity, a “SHIPPED” event is created. Step 240 represents a SHIPPED event.

At step 260, as an item arrives at an entity, a “RECEIVED” event is created. There may be several events recorded by the entity which receives the item, including RECEIVED at step 270, RAISED at step 280, and PROCESSED at step 290. The receiving entity may ship the item to another entity to continue the processing as shown by the dashed line from step 260 to step 220.

The RECEIVED event typically includes a date/time stamp. This time stamp permits a determination of whether there is a gap or lapse in the location records. Typically, all events would have a date/time stamp.

The first entity registering the item puts an RFID tag or other unique identification on the item, and this tag becomes one of the identifiers for that Item. There may be other cross-referenced ID numbers for the Item such as a proposed ISO numbering system.

A rebate system that pays participants for information value received may be implemented. The rebate amounts and the mechanics will be determined by terms of trade. For example a database can store the each owner's desire to share process information with later owners. Later buyers will be given the option of purchasing the process information (provided that process information is not required by law), and a portion of the purchase price will be routed back to the prior owner who entered the process information.

In one embodiment, for each registration, a database entry is created in a transactional event database, relational database, or tabular database as discussed in more detail in the embodiment description below. The event entries typically include date and time of the registration; a unique item identification including the current product transformation state such as live animal, split carcass on the rail, primal, sub-primal, trim, grind, etc.; an entity private ID number, a COOL event (COOL-BORN, COOL-RAISED/PRODUCED, COOL-PROCESSED/HARVESTED), and a country event detail such as USA, Mexico, Canada, Australia, etc.

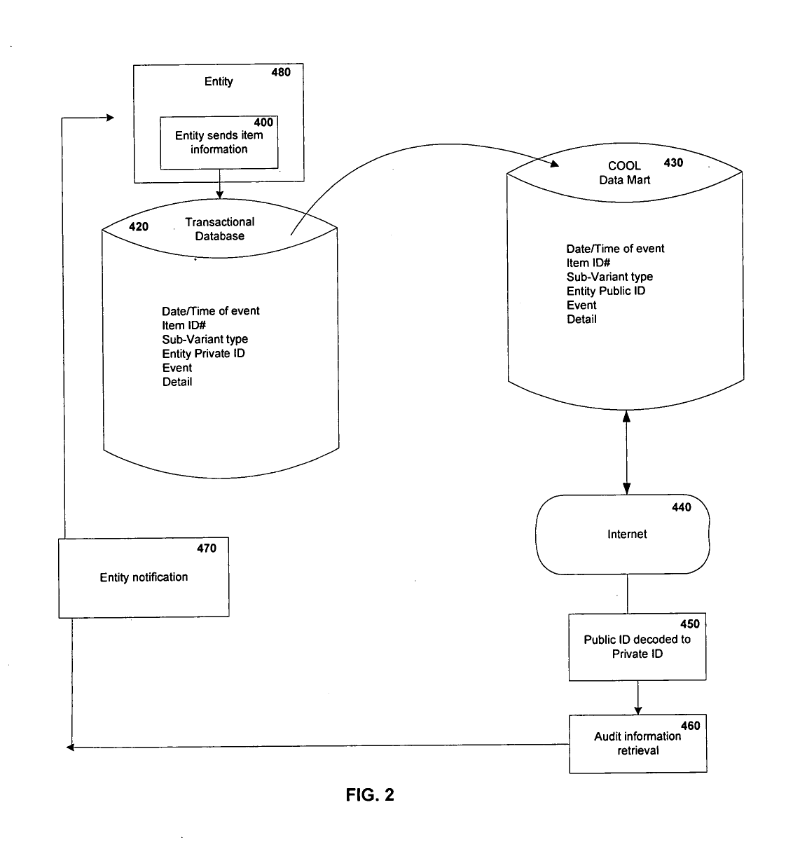

Referring now to FIG. 2 which is a schematic of a system, at step 400 an entity 480 sends information on an item to a service provider, and the information is stored in one or more transactional database 420 as discussed in the US20030177025A1 patent application.

A record entry is extracted from the one or more transactional database 420 and loaded into at least one COOL data mart 430 for each ownership change. An ownership change is the transfer of the item from one entity to another entity. The event entries in the data mart typically include date and time of the registration; a unique item identification; an entity private ID number; a COOL event; and a country event detail as described above, EXCEPT that the entity private ID number is replaced in the COOL data mart with a Public ID number synonym. The data mart 430 is an example of a data view where the entity private ID is replaced with a public ID.

In practice, a single entity's public ID number synonym will be changed at regular intervals, such as daily, weekly, monthly, or after a certain number of units of production. It can also be changed at random intervals, such as every random number of minutes, or random number of units of production. It is often desirable to change the public ID number synonym at random intervals. For instance, if the public ID number synonym were changed at regular intervals, then security can be compromised by looking at volume over time. In a small supply network, a public ID associated with a high volume of items, such as 1500 animals per day, would suggest a limited number of supplying entities. However, if the data for the 1500 animals is randomly assigned different public IDs for every 30 animals, neither the interval, nor the quantity of animals for each Public ID, can be used to identify a difference between a large-volume producer vs. a small-volume producer; each distinct Public ID will only have up to 30 animals in a given day.

The public ID number synonym is a number that is the ID used in all public reports. This public ID number changes each time period, such as in a month, using a scheme that will ensure that all items registered by that entity in month one will have the same public ID number, but in month two and subsequent months, there will be a different public ID number assigned to items from that same entity. The purpose of this change of public ID is to provide confidentiality to each entity and to make it very difficult to determine who is providing the items. In one example, a cross-reference between the private ID number and the various public ID numbers is maintained such as by the service provider or the data backbone supplier. In another example, a special encryption/decryption algorithm is used when creating a public key such that the Private ID can be ascertained directly from the Public ID.

In one embodiment, the public ID contains a key to access the private ID. In one example, the public ID number is a 16 digit identifier that begins with any character other than the unique character assigned to private IDs. In this example, private identification numbers begin with the @ character, and public identification numbers do not begin with the @ character. In this example, the first three alphanumeric characters of the public ID specify the iteration (column) of the table in which to look for the private ID, and the remaining 13 digits comprise the offset. The offset changes with each time period. In this example, the data mart 430 is a relational database the public ID number may be a smart key.

The data mart 430 may be in communication with the Internet 440, and the public ID may be decoded into the private ID at step 450 through the Internet.

In this example the decoding from public to private keys may be performed in an audit. When an inspector arrives at a retail establishment, the inspector can scan a retail item to query its information. The inspector's only task in COOL is to verify whether the product is properly labeled and to conduct appropriate audits.

At step 460, the scanning device creates a query of the COOL registration data mart providing the packaged ID number for a food item. The COOL registration data mart then determines the one-back location (the location of the entity which provided the item to the current entity) that provided the product, displays that information to the inspector, and then builds a table of all food item components or ingredients that could possibly have contributed to that food item. This list will usually be more than the single item if the packing plant did not track individual animals through fabrication, or if the product was a blended product such as ground beef.

The next report on the scanning device is a table showing the three COOL events as columns, the possible countries on the rows, and the percentage of all possible animals falling within each cell on the table. If the product was labeled as all from the USA for all three stages, and the scanning device showed there were 110 animals all born, raised, and harvested in the USA, then the inspector can quit with a satisfactory finding. If not, the inspector can dig more deeply.

If the inspector digs more deeply, the inspector can request the scanning device to show a traceability map for the product using the public ID numbers. A traceability map provides a listing for a food item at any stage of production of all ingredients used and the entity or entities who owned that ingredient at all prior stages of production. Using the current invention, this identification would not be the name of the previous entities but, rather, their public ID as defined herein.

To perform the audit, it is unlikely the inspector will test each branch of the traceability map, but would audit randomly selected branches. When a selected branch is requested, the inspector would query the wireless device or other communication device, either wired or wireless, to decode the public ID number into the private entity ID number and the name and address of the entity. The service provider who is maintaining the cross-reference tables of public and private identifications would then communicate back to the inspector the actual name, address and contact information of the entity.

When the system decodes the public ID number, the system records that the ID number was decoded and notifies the entity at step 470 that the entity has been identified in the chain and may be contacted by an inspector for further follow-up.

### DETAILED DESCRIPTION OF EMBODIMENT—BEEF EXAMPLE

This example is simplified in that a typical food supply chain may involve many more processing entities and processing locations.

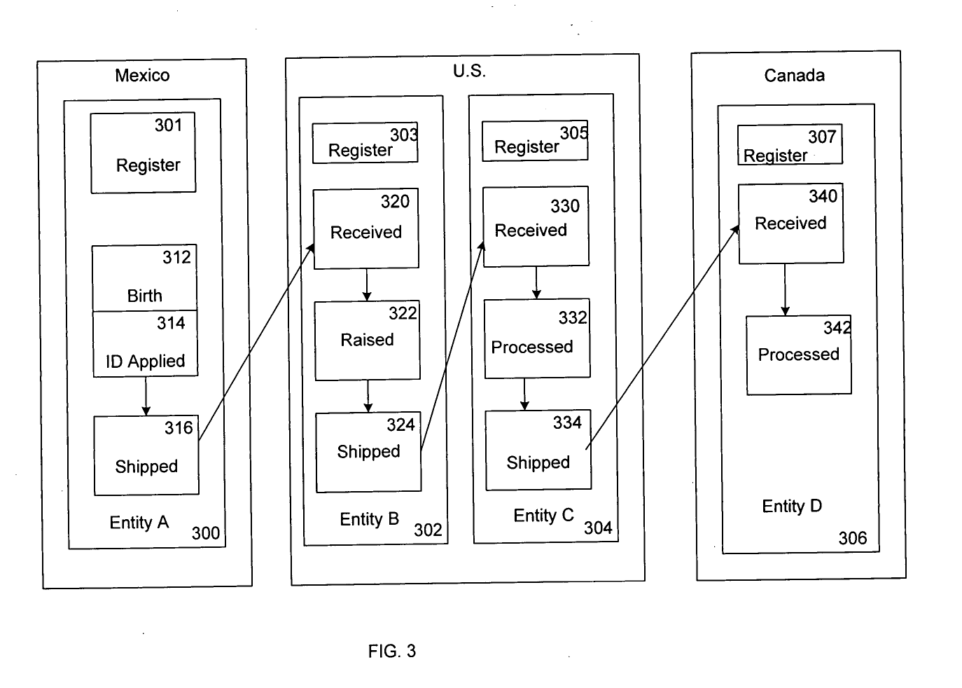

Referring now to FIG. 3, various countries including Mexico, the United States, and Canada are represented as being in the supply chain for a food item. Entity A represented by box 300 is in Mexico, entity B represented by box 302 is in the United States, entity C represented by box 304 is in the United States, and entity D represented by box 306 is in Canada.

Box 301 represents registration of entity A with a service provider. Boxes 303, 305 and 307 represent the registration of Entities B, C and D with a service provider.

Box 312 represents the birth of an animal. Box 314 represents the application of an identifying number to the animal. Box 316 represents an animal being shipped from entity A.

Box 320 represents the receiving of the animal by Entity B. Box 322 represents the raising of the animal at entity B. Box 324 represents the shipping of the animal from entity B.

Box 330 represents receiving the animal at entity C. Box 332 represents processing the animal at entity C. Box 334 represents shipping the animal from entity C.

Box 340 represents receiving the animal at entity D. Box 342 represents processing the animal at entity D.

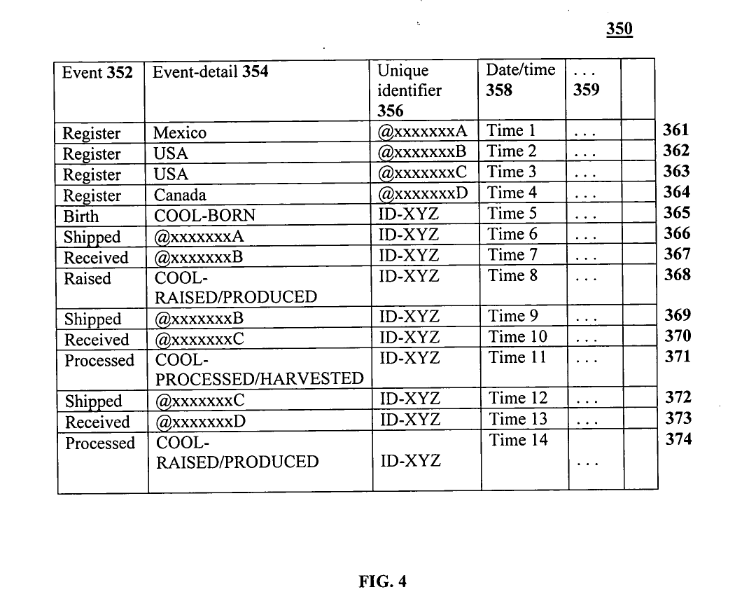

The table in FIG. 4 represents a portion of a transactional event data base 350 representation for recording information about the events or relational data. In this example, a transactional event database is shown where column 352 is events, column 354 is event details associated with the events, column 356 is a unique identifier for the entity or food item, such as a private entity ID or an animal identity ID associated with the event, column 358 is a date and time stamp associated with the event, and column 359 represents other information such as global unique identifiers as discussed in the US20030177025A1 patent application. In other embodiments the data may be represented other types of databases including one or more relational databases or tabular databases.

Rows 361 through 374 show representation of the registration, shipping, receiving, and processing events as shown in FIG. 3. Row 361 represents the entity A registration event at box 301, and rows 362-364 represent the entity registration events for entities B-D in boxes 303, 305, and 307.

In rows 361-364 the events are register events, the event detail is the country where the entity is located, and the unique identifier is the unique identifier such as the 16 character alphanumeric string for the entity's private identification number. In this example, the unique identifiers are shown as simplified strings which begin with the special character “@” and which end in A, B, C or D to represent those entities. In practice the unique identifier maybe any sting of characters.

Row 365 represents the birth of an animal at box 312. The birth is one of the COOL events, so the event is designated as COOL-BORN. The animal identification is typically a unique identifier, and is represented in this example as a particular identification “ID-XYZ”. The event detail is the entity A unique identifier. A time stamp is typically provided. In this example, column 359 represents additional data elements such as a global unique event identifier or other elements to support data security as discussed in the US20030177025A1 patent application.

Row 366 is the item shipped event of box 316. The event is “Shipped”, the event detail is the unique private identifier for entity A, and the unique identifier for the event is the animal ID-XYZ. Row 367-374 show similar event representation for the other boxes of receiving, raising, processing and shipping the animal as shown in FIG. 3.

In this example, the entity registration events; the COOL events such as birth and processing; and the shipping and receiving events are all recorded in the same event structure of the transaction event data base. In practice, additional event data such as measurement data may be included in the transaction database. Specific information from the transaction event databases are typically stored in data marts to facilitate the efficient execution of specific tasks, such as COOL audits discussed above.

In this example, a data mart or other data view is constructed from the transactional event data base 350 such that a public ID is used rather than a private ID for each entity identification.

### DETAILED DESCRIPTION OF EMBODIMENT—CONVERSION OF PUBLIC IS TO PRIVATE ID

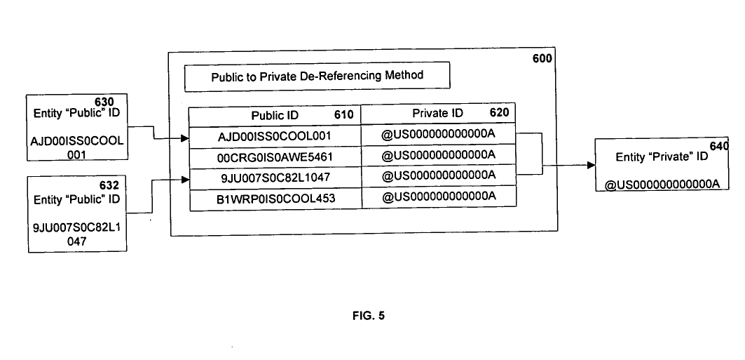

FIG. 5 is an example of a de-referencing table 600, such as a reference data mart, where public IDs such as 630 and 632 are randomly generated and stored in column 610 along with the private ID 620. In this method, whenever a public ID is needed, such as when populating a data mart, or exposing a data view, a new public ID is randomly generated, a new row is created in a reference table, and the public ID is related to the private Id. Whenever the private ID 640 is needed, the public ID such as 630 or 632 is looked up in the reference table, and the private ID is determined.

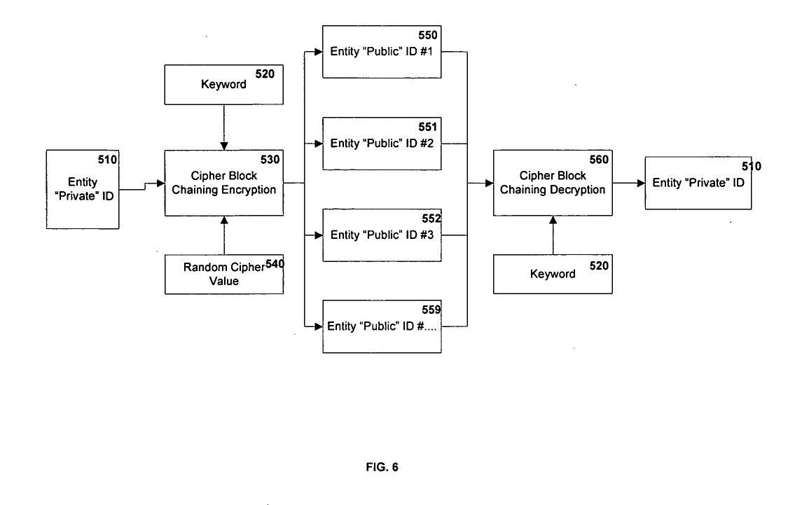

FIG. 6 is a flowchart illustrating an alternative method of keyword encryption for creating and decoding public IDs. In this embodiment, a entity private ID is presented at step 510. A keyword 520 and a random cipher value 540 are used in a cipher block chaining encryption step 530 to create a plurality of public IDs illustrated as public ID#1 550, public ID#2 551, public ID#3 552, and public ID#N 559. Each of these public IDs may be used in the data view, and each can be deciphered to the private ID 510 by using the cipher block chaining decryption step 560 and the keyword 520. Since only the keyword is required to decipher the ID, this method eliminates the need for reference data to determine the private ID, and permits the assignment of a plurality of unique public IDs to smaller units of production of the food item components. A single keyword can be used to translate multiple public IDs into private IDs.

Typically, safeguards would be applied to protect the keyword, such as varying the keyword over time.

Other techniques for data base representation, data marts and data views, and encryption are well known to those skilled in the art, and may be used in the current invention.

What is claimed is:

1. A method for anonymous trace-back for a food item label claim, the food item comprising at least one food item component, the component associated with a plurality of entities, each entity having a private ID, the label claim related to at least label claim event in the processing history of the food item component, the method comprising:
recording event data in at least one database, the event data comprising
a unique private entity identification number for each entity,
a unique identification number for the food item component,
at least one label claim event, and
at least one shipped event and at least one received event, such that the shipped event records the shipment of a component from a first entity, and the received event records the receipt of the component at a second entity;
extracting at least one data view from the database, the data view comprising for each label claim event:
date and time,
unique identification number for the component of the food item,
the transformational state of the food item,
the label claim event identification,
an event detail, and
a entity public ID, such that the entity public ID can be used to obtain the entity private ID for the entity; and
querying the data mart to determine the public ID for an entity; and
decoding the public ID to a private ID for the entity.

2. The method of claim 1 wherein the data view is a data mart.

3. The method of claim 1 wherein
decoding the public ID to a private ID for the entity is performed with an encryption keyword technique.

4. The method of claim 1 wherein
decoding the public ID to a private ID for the entity is performed with a reference table.

5. A system for anonymous trace-back for a food item label claim, the system comprising:
a food item comprising at least one food item component;
a label claim for the food item, such that the label claim is related to at least label claim event in the processing history of the food item component;
at least one entity associated with the food item component, such that the entity has a private ID and at least one public ID;
at least one database, the database comprising
a unique private entity ID for each entity,
a unique identification number for the food item component,
at least one label claim event, and
at least one shipped event and at least one received event, such that the shipped event records the shipment of a component from a first entity, and the received event records the receipt of the component at a second entity;
at least one data view, the data view comprising for each label claim event:
date and time,
unique identification number for the component of the food item,
the transformational state of the food item,
the label claim event identification,
an event detail, and
a entity public ID, such that the entity public ID can be used to obtain the entity private ID for the entity.

6. A method of auditing the accuracy of country of origin labeling of a food item comprising at least one food item component, the component associated with a plurality of entities, each entity located in a country and having a private ID, the method comprising:
recording event data in at least one database, the event data comprising
a unique private entity identification number for each entity,
a unique identification number for the food item component,
a plurality of COOL events associated with the food item component, the COOL events comprising BORN, RAISED/PRODUCED, and PROCESED/HARVESTED or other phrases used to denote production phases, and
at least one shipped event and at least one received event, such that the shipped event records the shipment of a component from a first entity, and the received event records the receipt of the component at a second entity;
extracting at least one COOL data view from the event database, the COOL data view comprising for each COOL event, shipped event, and received event associated with a component of the food item:
date and time,
unique identification number for the component of the food item,
the transformational state of the food item,
the event identification,
an event detail, and
a entity public ID, such that the entity public ID can be used to obtain the entity private ID for the entity; and
querying the COOL data mart to audit the country of origin labeling of the food item, the querying including converting the public ID to a private ID for at least one entity.

7. The method of claim 6 wherein
the food item is an edible food article comprising fruits or vegetables, grains or oilseeds, livestock.

8. The method of claim 6 wherein
the private identification number is a 16-character alphanumeric that begins with a defined character.

9. The method of claim 6 wherein
the database is at least one transactional event database.

10. The method of claim 6 wherein
the database is at least one relational database.

11. The method of claim 6 wherein
the data view is at least one data mart.

12. The method of claim 11 wherein
the data mart is a relational database.

13. The method of claim 6 wherein
converting the public ID to a private ID for the entity is performed with an encryption keyword technique.

14. A method of determining country of origin labeling of a food item comprising at least one food item component, the component associated with a plurality of entities, each entity located in a country and having a private ID, the method comprising:
recording event data in at least one database, the event data comprising
a unique private entity identification number for each entity,
a unique identification number for the food item component,
a plurality of COOL events associated with the food item component, such that the COOL events comprising BORN, RAISED/PRODUCED, and PROCESED/HARVESTED, and
at least one shipped event and at least one received event, such that the shipped event records the shipment of a component from a first entity, and the received event records the receipt of the component at a second entity;
extracting at least one COOL data view from the event database, the COOL data view comprising for each COOL event, shipped event, and received event associated with a component of the food item:
date and time,
unique identification number for the component of the food item,
the transformational state of the food item,
the event identification,
an event detail, and
a entity public ID, such that the entity public ID can be used to obtain the entity private ID for the entity; and
determining the countries to include on the COOL label.

15. A system for determining and auditing country of origin labeling of a food item, the system comprising:
a food item comprising at least one food item component;
a country of origin label for the food item, the label alleging the countries of origin for the food item component;
a plurality of entities associated with a food item component, such that each entity is located in a country and each entity has a private ID and at least one public ID;
at least one event database, the event data comprising
a unique private entity identification number for each entity,
a unique identification number for the food item component,
a plurality of COOL events associated with the food item component, such that the COOL events comprising BORN, RAISED/PRODUCED, and PROCESED/HARVESTED, and
at least one shipped event and at least one received event, such that the shipped event records the shipment of a component from a first entity, and the received event records the receipt of the component at a second entity; and
at least one COOL data view comprising for each COOL event, shipped event, and received event associated with a component of the food item:
date and time,
unique identification number for the component of the food item,
the transformational state of the food item,
the event identification,
an event detail, and
an entity public ID, such that the entity public ID can be used to obtain the entity private ID for the entity.

16. The method of claim 15 wherein
the event database is at least one transactional event database.

17. The method of claim 15 wherein
the event database is at least one relational database.

18. The method of claim 15 wherein
the data view is at least one data mart.

19. The method of claim 18 wherein
the data mart is a relational database.

20. The method of claim 15 further comprising
a reference table for converting the entity public ID to the entity private ID.
